(19) United States
(12) Patent Application Publication
(10) Pub. No.: US 2013/0325796 A1
(43) Pub. Date: Dec. 5, 2013

(54) System and Method for Integrating Databases in a Cloud Environment

(71) Applicants: Michael Basnight, Austin, TX (US); Keith Bray, Austin, TX (US); Daniel Morris, Austin, TX (US); Chris Sackman, San Antonio, TX (US)

(72) Inventors: Michael Basnight, Austin, TX (US); Keith Bray, Austin, TX (US); Daniel Morris, Austin, TX (US); Chris Sackman, San Antonio, TX (US)

(21) Appl. No.: 13/488,546

(22) Filed: Jun. 5, 2012

(51) Int. Cl. G06F 7/00; G06F 17/30

(52) U.S. Cl. 707/609; 707/E17.032; 707/E17.005

(57) ABSTRACT

A system and method for the integration of databases in a multi-tenant cloud environment. The method includes specific systems that integrate MS SQL and other database software with a cloud based infrastructure as a service platform, specifically OpenStack Nova. This method also includes certain optimization and rebalancing innovations to maximize databases in a cloud environment.

### BACKGROUND OF THE INVENTION

1. Field of the Invention

The present invention is directed generally to advancements in systems and methods for the integration of databases in a multi-tenant cloud environment. Specifically, this invention is directed to a system and method for enabling MS SQL databases to run on the cloud environment OpenStack Nova.

2. Description of Related Art

Computer-based databases permeate the modern economy. Entities of all sizes from governments to nearly every kind of business use databases as an integral part of their activities. In addition, more and more individuals and small groups are using databases for managing their activities from clubs, to churches, to personal data.

Currently, the creation and management of a relational database system requires intensive investments in datacenter facilities or database servers. This process requires costly hardware and software. Furthermore, to build and provision an enterprise level database requires expensive personnel and facilities to plan and implement the relational database system. Once the database has been created further personnel are required to manage and maintain the database. The development of cloud technologies has solved many of these former problems. A cloud environment allows access to professional datacenter facilities and servers at rates that are affordable. However, most database software programs are not compatible with a multi-tenant cloud environment. Therefore, there is a long felt need in the art for a system and method for the integration of databases software programs in a multi-tenant cloud environment.

### SUMMARY OF THE INVENTION

The present invention is directed to a method and system for enabling the integration of database software programs into a multi-tenant cloud environment. The invention includes methods to integrate database servers into a cloud environment that otherwise are not natively compatible with the cloud. One embodiment of this invention envisions the methods and systems using the commercially available database software package MS SQL and the cloud infrastructure as a service environment OpenStack Nova.

Many other objects, features, advantages, benefits, improvements and non-obvious unique aspects of the present invention, as well as the prior problems, obstacles, limitations and challenges that are addressed, will be evident to the reader who is skilled in the art, particularly when this application is considered in light of the prior art. It is intended that such objects, features, advantages, benefits, improvements and non-obvious unique aspects are within the scope of the present invention, the scope of which is limited only by the claims of this and any related patent applications and any amendments thereto.

To the accomplishment of all the above, it should be recognized that this invention may be embodied in the form illustrated in the accompanying drawings, attention being called to the fact, however, that the drawings are illustrative only, and that changes may be made in the specifics illustrated or described.

### BRIEF DESCRIPTION OF THE DRAWINGS

FIG. 1 is a high-level view of major components of a typical preferred embodiment of the present invention deployed using MS SQL as the core database software and OpenStack Nova as the cloud infrastructure as a service (IaaS) platform.

FIG. 2 is a detailed flow diagram of a typical preferred embodiment of the present invention.

### DETAILED DESCRIPTION OF PREFERRED EMBODIMENT

As previously stated, the present invention is directed to a method and system for enabling the integration of database software programs into a multi-tenant cloud enviromnent. The system includes methods to integrate database servers into a multi-tenant cloud environment that otherwise are not natively compatible with the cloud. One embodiment of this invention envisions the methods and systems using the commercially available database software package MS SQL and the cloud infrastructure as a service environment OpenStack Nova. This is accomplished by introducing various components that act as interfaces between otherwise incompatible software products. Furthermore, various optimization components are described below.

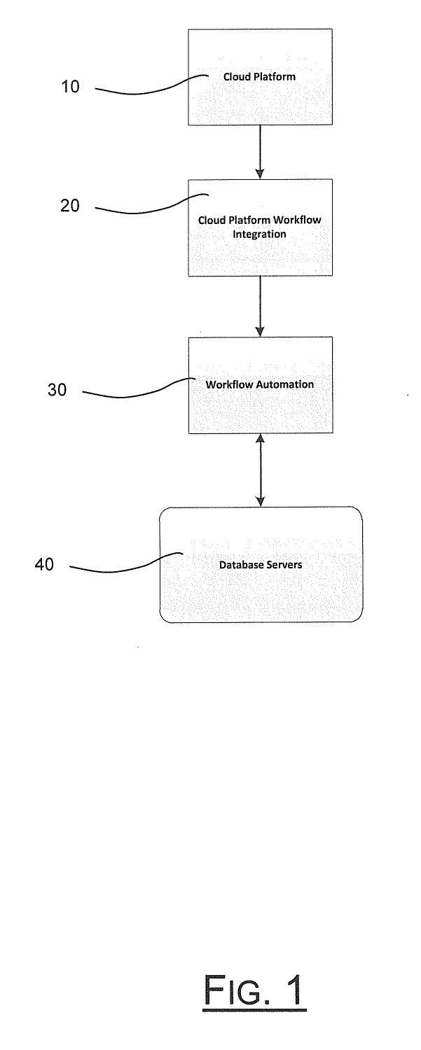

Turning to FIG. 1, which shows a high level view of a typical preferred embodiment of the present invention with all of its major components. Specifically, cloud platform 10 controls the Infrastructure as a Service (IaaS) cloud computing platform. These systems define drivers that interact with the underlying virtualization mechanisms of hardware computer systems. They are typically implemented in a datacenter on clusters of real or virtual servers. The cloud platform 10 allows the automatic provisioning of computer instances, network connections, and storage by request of the user. One embodiment of cloud platform 10 capitalizes on the OpenStack Nova software product (referred to as the “OpenStack Nova” for purposes of this description), which is commercially available in the United States as of the filing date of this description.

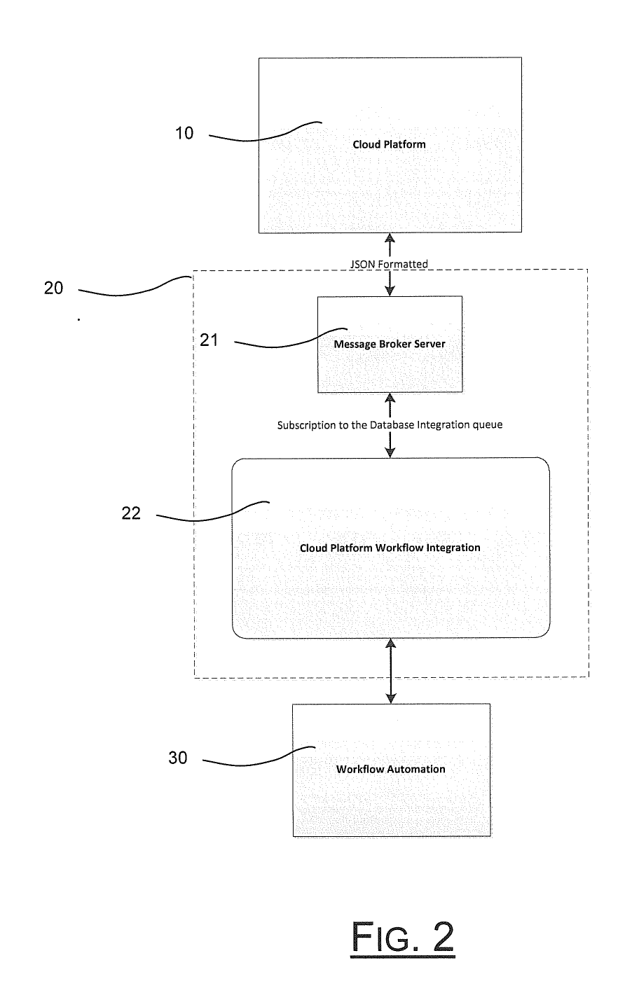

The cloud platform 10 interfaces with a Cloud Platform Workflow Integration 20. This is a pack of services that translates the instructions between the cloud platform 10 and is more fully described in FIG. 2. The Cloud Platform Workflow Integration 20 interfaces with the workflow automation 30. The workflow automation 30 can be any number of various commercially available software or other methods of workflow automation. In the present embodiment the workflow automation 30 is a proprietary to Microsoft software program called System Center Orchestrator (SCO). The workflow automation 30 interfaces with the database servers 40, which provides the core database functionality.

In some embodiments of the present invention, the method and systems described in FIG. 1 are provided via computer software, either via the internet, via a stand-alone software application operating independently or in connection with other software systems, or some combination of the two. As well, embodiments may come in any known form and may also be implemented by hardware, software, scripting languages, firmware, middleware, microcode, hardware description languages, and/or any combination thereof. When implemented with coded programming, it should also be understood that the program code or code segments to perform the necessary steps or tasks of alternative embodiments may be coded in solid state or may be stored in a machine-readable medium such as a computer storage medium. A code segment or machine-executable step or instruction may represent a procedure, a function, a subprogram, a program, a routine, a subroutine, a module, a software package, a script, a class, or any combination of instructions, data structures, and/or program statements. Executable code segments may also be coupled to other code segments or to a hardware circuit by passing and/or receiving information, data, arguments, parameters, and/or memory contents, which may be passed, forwarded, or transmitted via any suitable means including memory sharing, message passing, token passing, network transmission, etc.

With reference again to FIG. 1, a particularly preferred embodiment is provided in the form of software that is installed and adapted to interact with the databases, servers and terminals of a data management system. It should be understood that the graphical representation of the system is an exemplary reference to any number of software systems that may be implemented by the present invention.

With the major components of the system described we turn now to FIG. 2, which detail in more particularity the innovations of the present invention. All communication requests to and from the cloud platform 10 are translated and routed by the Cloud Platform Workflow Integration 20. In the preferred embodiment the cloud platform 10, OpenStack Nova uses JavaScript Object Notation (JSON), a human readable data interchange format know in the art, as the communication protocol between it and the Cloud Platform Workflow Integration 20. While JSON is the format of the preferred embodiment, it is possible to use any number of standard or proprietary communication protocols.

All of the JSON formatted data is communicated to the Message Broker Server 21. The Message Broker Server 21 is software or hardware infrastructure that supports the sending, receiving, and queuing of messages in a standard format between various software components. The Message Broker Server 21 acts a communications layer between the cloud platform 10 and the Cloud Platform Workflow Integration 22. In the present embodiment the Message Broker Server 21 uses a RabbitMQ server as its message broker and the Advanced Message Queuing Protocol (AMQP) as its message protocol.

Essentially Message Broker Server 21 acts as the middleman between the cloud platform 10 and the Cloud Platform Workflow Integration 22. The cloud platform 10 and the Cloud Platform Workflow Integration 22 are subscribed to and monitor the messages in the Message Broker Server 21. As instructions are posted in the Message Broker Server 21 in a format that each service can understand. Then as those instructions are posted, the appropriate actions by the services can be taken.

The Cloud Platform Workflow Integration 22 serves as the interpreter and translator of the present invention. Thus, the Cloud Platform Workflow Integration 22 takes the instructions and messages from the cloud platform 10 and translates them into a format understood by the workflow automation 30 and vice versa. In the present invention, the Cloud Platform Workflow Integration 22 is C# code that has been customized to understand the JSON formatted messages transmitted to the Message Broker Server 21 by the cloud platform 10. This code then translates these instructions into SCO Runbooks which implement the actions. The Cloud Platform Workflow Integration 22 also works in reverse by translating SCO instructions into JSON formatted messages understood by OpenStack Nova.

Finally the workflow automation 30 controls the database server 40. In the present invention the database server 40 is a commercially available relational database server. Alternative embodiments of the present invention may substitute different relational database servers. In all embodiments, the relational database server provides the core database services. Specifically those database services are the storing, retrieval, and manipulation of data as requested by other software applications. In some embodiments the database server 40 could be virtual, actual, or a mix of virtual and actual servers.

Together the innovations described by the present invention allow the integration of MS SQL and other databases into a multi-tenant cloud environment. Alternative embodiments of certain aspects of the present invention also include adaptations of the methods and systems described above, such as adaptations to be used for providing a straightforward method and system by which a database software package can be adapted, integrated, and optimized for use on a cloud environment. It will be evident to those of skill in the art whether and how systems and methods of the present method can be adapted for use with any particular database software or cloud environment.

Specific details are given in the above description to provide a thorough understanding of various preferred embodiments. However, it is understood that these and other embodiments may be practiced without these specific details. For example, processes may be shown in block diagrams in order not to obscure the embodiments in unnecessary detail. In other instances, well-known processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have many additional steps not included in the figure. A process may correspond to a method, a function, a procedure, a subroutine, a subprogram, etc. When a process corresponds to a function, its termination corresponds to a return of the function to the calling function or the main function.

Embodiments of the invention may involve use middleware and/or other software implementation; the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may be downloadable through an internet connection service. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that contain or carry instruction(s) and/or data.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

While the principles of the disclosure have been described above in connection with specific apparatuses and methods, it is to be clearly understood that this description is made only by way of example and not as limitation on the scope of the disclosure. Whether now known or later discovered, there are countless other alternatives, variations and modifications of the many features of the various described and illustrated embodiments, both in the process and in the system characteristics, that will be evident to those of skill in the art after careful and discerning review of the foregoing descriptions, particularly if they are also able to review all of the various systems and methods that have been tried in the public domain or otherwise described in the prior art. All such alternatives, variations and modifications are contemplated to fall within the scope of the present invention.

Although the present invention has been described in terms of the foregoing preferred and alternative embodiments, these descriptions and embodiments have been provided by way of explanation of examples only, in order to facilitate understanding of the present invention. As such, the descriptions and embodiments are not to be construed as limiting the present invention, the scope of which is limited only by the claims of this and any related patent applications and any amendments thereto.

What is claimed is:

1. A method for integrating database servers into a cloud environment that otherwise are not natively compatible in a cloud environment, said method comprising:
a. communicating information and instructions to a common message queue;
b. determining whether any action should be taken based on said information and instructions in said message queue; and
c. providing instructions regarding said action to the appropriate software in a format understandable by said software.

2. A system for integrating database servers into a cloud environment that otherwise are not natively compatible in a cloud environment, said system comprising:
a. a cloud platform;
b. a database software platform;
c. a message queue to receive standard formatted messages containing instructions and information from said cloud platform or a manager; and
d. a said manager that reviews said instructions and information from said message queue, evaluates said instructions and information, initiates actions based on said instructions and information and communicates said actions to said message queue or said database software platform.

3. The system of claim 2 wherein said cloud platform is OpenStack Nova.

4. The system of claim 3 wherein said database software platform is Microsoft SQL.

5. The system of claim 4 wherein said message queue is RabbitMQ.
